(19) United States
(12) Patent Application Publication
(10) Pub. No.: US 2017/0154112 A1
(43) Pub. Date: Jun. 1, 2017

(54) Method of masking data making up a user profile associated with a node of a network

(71) Applicants: INRIA INSTITUTE NATIONAL DE RECHERCHE EN INFORMATIQUE ET EN AUTOMATIQUE, LE CHESNAY (FR); UNIVERSITE DE RENNES 1, RENNES CEDEX (FR)

(72) Inventors: Anne-Marie Kermarrec, Rennes (FR); Sebastien Gambs, Rennes (FR); Mohammad Nabil Alaggan, Rennes (FR)

(73) Assignees: INRIA INSTITUT NATIONAL DE RECHERCHE EN INFORMATIQUE ET EN AUTOMATIQUE, LE CHESNAY (FR); UNIVERSITE DE RENNES, RENNES CEDEX (FR)

(21) Appl. No.: 14/388,523

(22) PCT Filed: Mar. 22, 2013
(86) PCT No.: PCT/EP2013/056133

§ 371 Date: Jul. 13, 2015

(30) Foreign Application Priority Data
Mar. 27, 2012 (FR) 12 52716

(51) Int. Cl. G06F 17/30; H04L 29/08

(52) U.S. Cl. CPC G06F 17/30867; H04L 67/306; G06F 17/30283; G06Q 50/01

(57) ABSTRACT

The invention relates to a method of masking data making up a user profile associated with a node of the network, a user profile consisting of a sub-set of elements present from among a set of possible elements. The masking method includes a step for obtaining an initial data structure including a pre-determined number of binary elements, a so-called binary element being able to have a value from two possible values, the initial data structure being representative of the elements present in the user profile, and, for at least one portion of said binary elements, a step for applying a probabilistic inversion operation of the value of said binary element, depending on a probability value calculated from a pre-determined confidentiality parameter, giving the possibility of obtaining a masked data structure representative of the elements present in the user profile.

### CROSS-REFERENCE TO RELATED APPLICATIONS

This application in the National Stage of International Application PCT/EP2013/056133 filed Mar. 22, 2013 and which published as WO 2013/144031 on Oct. 3, 2013. The PCT claims priority to French Patent Application Serial No. 12 52716 filed Mar. 27, 2012. All of the above application are incorporated by reference in their entirety.

### FIELD OF THE INVENTION

The present invention relates to a method of masking data making up a user profile associated with a node of a network, and a method for estimating the similarity between a first node and a second node of a network, each node having an associated user profile.

The invention belongs to the field of observing privacy in networks, notably in distributed networks.

### BACKGROUND

Nowadays, communications via internet are widely generalized, and many distributed networks are created on the basis of data and preferences from users, such as for example social networks. Typically, such a distributed network is formed with nodes, each node being associated with a user and having an associated user profile, consisting of a sub-set of elements present from among a set of possible elements, relating to particularities or to preferences of the user.

Various applications use the user profile, for example in order to generate groups of users having common interests or for recommendation systems able to propose to a user, new products compliant with his/her interests. Such applications require the calculation of a similarity between user profiles in order to determine their proximity according to the data or preferences expressed in the user profiles.

It is known, in a centralized network in which the representative nodes of the users are considered as clients, how to use a central server for carrying out such a similarity calculation. This poses two types of problems, a confidentiality problem of the data making up the user profile, on the one hand, and a problem of computing power to be applied by such a central server carrying similarity calculations on the other hand.

### SUMMARY

A goal of the invention is to propose a method of masking data making up a user profile, giving the possibility of obtaining a representation of a user profile which has guarantees in terms of confidentiality while having good usefulness for a similarity calculation between profiles associated with the nodes of a network.

For this purpose, the invention according to an example relates to a method of masking data making up a user profile associated with a node of a network, a user profile consisting of a sub-set of elements present from among a set of possible elements. The method of the invention includes the following steps:
obtaining an initial data structure including a pre-determined number of binary elements, a so-called binary element may assume one value from among two possible values, the initial data structure being representative of the elements present in the user profile, and
for at least one portion of said binary elements, applying a probabilistic operation for inverting the value of said binary element, depending on a probability value, depending on a pre-determined confidentiality parameter, giving the possibility of obtaining a masked data structure representative of the elements present in the user profile.

Advantageously, the method of the invention gives the possibility of obtaining a masked data structure representative of the elements present in the user profile, which observes a pre-determined confidentiality level.

The method of masking data according to the invention may have one or several of the features below:
the obtaining step includes the application of a filtering operation on said sub-set of present elements with which it is possible to obtain a probabilistic data structure representative of the presence of elements in the user profile from among the set of possible elements with an associated certainty level;
said filtering operation is Bloom filtering, associating a number M of binary values with said sub-set of present elements, the M binary values being obtained by successively and independently applying K hash functions, each hash function producing a pseudo-random association between an element present in the user profile and a corresponding binary element which is set to a first binary value from among the two possible binary values;
said confidentiality parameter is a differential confidentiality parameters relating to the confidentiality of the binary elements of said initial data structure, and said probability value is comprised between 1/(1+exp(ε)) and 0.5;
said confidentiality parameter further depends on the number K of applied hash functions, and said probability value is comprised between 1/(1+exp(ε/K)) and 0.5.

According to another example, the invention relates to a method for estimating similarity between a first node and a second node of a network, each node having an associated user profile, a user profile consisting of a sub-set of elements present among a set of possible elements. The estimation method includes the steps:
obtaining an initial data structure or a masked data structure obtained by applying a masking method as described briefly above, representative of the user profile associated with the first node,
receiving a masked data structure representative of the user profile associated with the second node obtained by applying a masking method as described briefly above, and
estimating a similarity value between said first node and second node depending on said data structures.

Advantageously, the similarity estimation may be applied onto any node of the network insofar that the similarity estimation is made from the obtained masked data structures. In particular when the similarity estimation is applied onto various nodes of the network, like in a distribution system of the peer-to-peer type, this gives the possibility of getting rid of the need for a central server carrying out all the calculations.

The similarity estimation method according to the invention may have one or more of the features below:
it is applied onto said first node, and in said obtaining step, an initial data structure representative of the user profile associated with the first node is obtained;
the estimation step includes the calculation of a scalar product between said initial data structure and said masked data structure;
it is applied onto a node of the network different from said first node and second node, and in the obtaining step, a masked data structure representative of the user profile associated with the first node is obtained.

### BRIEF DESCRIPTION OF THE DRAWINGS

Other features and advantages of the invention will become apparent from the description which is made below, as an indication and by no means as a limitation, with reference to the appended figures, wherein:

FIG. 1 is an exemplary network applying the invention,

FIG. 2 is a diagram illustrating functional blocks of a device capable of applying a data masking method and/or a similarity estimation method according to the invention,

FIG. 3 is a flow chart representative of the steps applied for masking the data making up a user profile according to an embodiment of the invention, and

FIG. 4 is a flow chart representative of the applied steps in a method for estimating similarity according to an embodiment of the invention.

### DETAILED DESCRIPTION

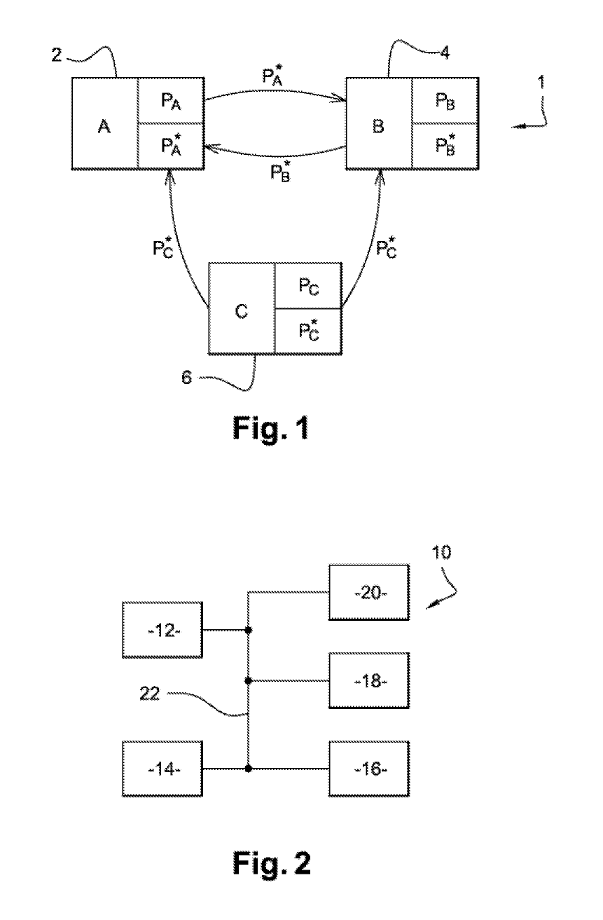

FIG. 1 schematically illustrates a network 1 according to an example of the invention, consisting of nodes 2, 4, 6, each node of the network being able to communicate with the other nodes of the network and having an associated user profile.

Of course, a network according to the invention in practice consists of any number of nodes; the number of nodes may change dynamically.

In practice, a node of the network is implemented by a programmable device of the personal computer type, having computing capabilities and the capabilities for connecting to a communications network. For example, the nodes 2, 4, 6 are connected via the Internet network.

The nodes 2, 4, 6 of the network 1 each have an identifier, the identifiers being respectively noted as A, B and C.

Each node has an associated user profile, consisting of a sub-set of elements present among a set of possible elements. The set of possible elements is either finite or not.

For example, the present elements designate addresses of the URL (“Uniform Resource Locator”) type of documents for which the user has expressed preference.

Each node computes and stores in memory an initial representation of the associated user profile, respectively noted as P_{A} for node A, P_{B} for node B, and P_{C} for node C. This initial representation, also called a private profile is calculated in a deterministic way.

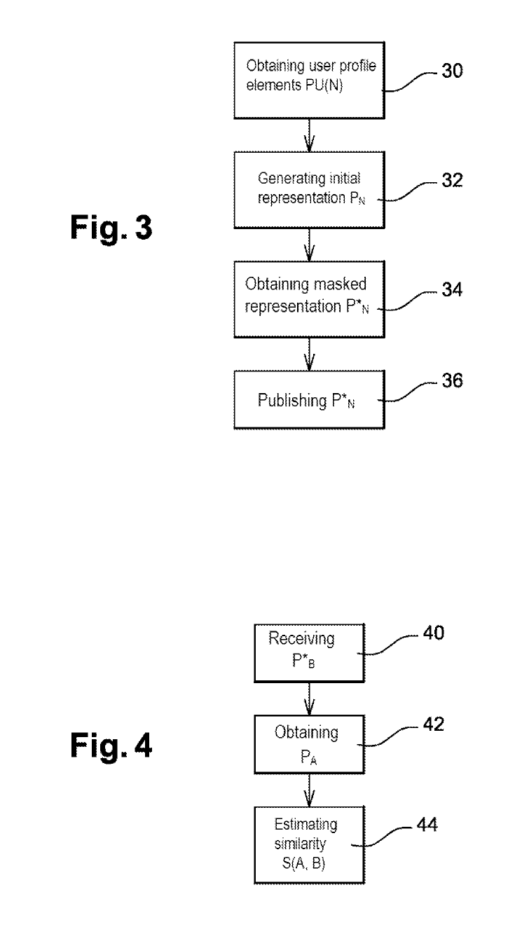

Moreover, each node calculates and stores a masked representation of the associated user profile, also called public profile, respectively noted as P*_{A} for node A, P*_{B} for node B, and P*_{C} for node C, the calculation being carried out according to one of the embodiments of the invention explained in detail hereafter with reference to FIG. 3. This masked representation is probabilistic, an uncertainty level being introduced on the elements making it up, so as to preserve confidentiality and prevent a third party from being able to deduct the element present in the user profile from its masked representation.

Thus, the masked representations may be published, i.e. transmitted to other nodes of the network 1, while guaranteeing confidentiality and a security level with respect to malicious attacks seeking to retrieve the masked or hidden data of the user profile. The initial representations are private representations, which are locally stored on each node and which are not made public.

As illustrated by arrows, illustrated in FIG. 1, the respective nodes send the masked representation of their profile to other nodes of the network. Each node is able to calculate a similarity value according to a pre-determined similarity measurement, between a masked profile representation received from another node and its own initial representation, as explained in detail hereafter.

Alternatively, each node transmits its public profile to a central server or to another node of the network which carries out the similarity computations between two public profiles, therefore in their masked representation.

In the example of FIG. 1, the node A receives the masked representations of the nodes B and C, node B receives the masked representations of nodes A and C.

Each of the nodes A and B is able to compute similarity values between nodes, and to provide these values to client applications for example. These nodes A and B then play the role of a server in the network 1.

For example, node A may estimate the similarities s(A, B) and s(A, C) from P_{A}, P*_{B} and P*_{C}, and node B may estimate the similarities, s(B, A) and s(B,C) from P_{B}, P*_{A} and P*_{C}.

Node C does not receive any masked representation of other nodes so cannot carry out any similarity computation. Node C plays a role of a client.

Each node of a network according to the invention is applied on a programmable device, such as a computer, the main functional blocks of which are schematically illustrated in FIG. 2.

Thus, a programmable device 10 able to apply the invention comprises a screen 12, a means 14 for inputting commands from a user, for example a keyboard, which may be integrated into a touch screen, a central processing unit 16, capable of executing control programme instructions when the programmable device is on. The programmable device 10 also includes means for storing information 18, for example registers, capable of storing executable code instructions allowing software application of a method of masking the data and/or of a similarity estimation method according to the invention. Further, the programmable device 10 includes means 20 for communicating with a communications network.

The various functional blocks of the device 10 described above are for example connected via a communications bus 22.

FIG. 3 illustrates the main steps of an embodiment of the method of masking data representative of a user profile associated with a node N of a network according to the invention, applied by a central processing unit 16 of a device 10 associated with the node N.

Such a masking method is for example applied at every update of the user profile associated with a node N by the user, for example every time the user expresses a new preference.

Alternatively, such a masking method is applied periodically or on demand.

In a first step 30, the elements present in the user profile of the node N are retrieved. These elements are stored in a memory 18 of the device 10. For example the user profile consists of S elements PU(N)={p₁, . . . , pₛ}, which are present elements, each present element having a unique associated identifier. For example, the identifier is a number associated with a present element.

Subsequently, in the next step 32, an initial representation of the user profile is generated, as a data structure P_{N}={b₀, . . . , b_{M-1}} including a predetermined number M of binary elements, i.e. elements which may assume a value from among two possible values {Va, Vb}.

In the preferred embodiment, the possible values are Va=0, Vb=1, therefore each bᵢ is equal to 0 or to 1, and the initial data structure P_{N} is obtained by applying a Bloom filter on the elements pᵢ present in the user profile PU(N).

In a known way, a Bloom filter is a compact probabilistic structure for representation of data, giving the possibility of determining with a certain probability that an element is present in a set of data.

The number M of binary elements of the data structure P_{N} is fixed, regardless of the number S of elements present in the user profile PU(N).

In order to obtain the initial data structure with a Bloom filter, a number K of hash functions is used. Each hash function produces a match between an element present in the user profile PU(N) and an indexed i comprised between 0 and M−1, and the value of the binary element of index i, bᵢ, is set to 1, or more generally to a first value among the two possible values.

In practice, a hash function h applied to a present element pₖ carries out a pseudo-random draw with as a root the unique identifier of pₖ, modulo M, with which a numerical value may be obtained: h(pₖ)=I. The element bᵢ of the initial data structure is then set to the value 1: bᵢ=1.

The taking into account of a new present element pₛ₊₁ or the addition of an element of the user profile is accomplished by successively and independently applying each of the K hash functions h(pₛ₊₁), and setting to the value of 1 the designated bits of the data structure P_{N}, independently of the values already assumed by the bits bᵢ of the data structure.

Moreover, the data structure P_{N} obtained through the Bloom filter may also be used for checking for the presence or not of an element pₖ in the user profile associated with a node N. If at least one bit corresponding to a binary position obtained by the applied hash functions with the element pₖ is equal to 0, the element pₖ is certainly absent from the user profile.

On the other hand, the fact that all the bits corresponding to a binary position obtained by the K applied hash functions with the element pₖ are equal to 1, only gives the possibility of inferring the presence of the element pₖ in the user profile with a certain probability, since it is possible that collisions appear. Thus, a structure obtained by Bloom filtering is representative of the elements present in the user profile with an associated certainty level.

Next, in step 34, a masked representation of the user profile is obtained, noted as P_{N}*={v₀, . . . , v_{M-1}}, by applying a probabilistic flip operation of one or several binary values of the data structure obtained previously.

In an example, for each bit bᵢ of the initial data structure, an inversion of the binary value is either applied or not, depending on the result of a random draw, with a probability p.

A draw of a uniform variable X is carried out in the interval [0, 1]

The principle of the flip inversion operation of the value of the binary element bᵢ of the following:

If X≦p then vᵢ=flip(bᵢ)=1−bᵢ

Otherwise, vᵢ=flip(bᵢ)=bᵢ.

More generally, if X≦p, the binary element bᵢ changes value and assumes the other possible value, otherwise it remains unchanged.

According to an alternative, the probabilistic inversion operation is only applied on a sub-set of the binary elements of the initial data structure, for example on one binary element bᵢ out of two, or else on a sub-set of binary elements of the initial data structure also selected in a pseudo-random way.

A data structure P*_{N}, corresponding to a masked representation of the user profile is thus obtained at the end of step 34.

The probabilistic inversion operation is applied with a probability p. It clearly appears that the value of p has a strong impact on the obtained confidentiality level, and also on the usefulness level for similarity calculations of the obtained masked representation. Indeed, a value of p=½ results in a random result, which totally preserves confidentiality but in this case the masked representation is of no use for a similarity calculation.

It is important to determine a probability value p with a predetermined confidentiality level, according to a selected confidentiality metric, while preserving sufficient usefulness level.

By using the differential confidentiality metric, or “differential privacy” defined in the article “Differential privacy: a survey of results”, by C. Dwork, published in Proceedings of the 5th International Conference on Theory and Applications of Models of Computation, Xi'an, China, 25-29 Apr. 2008, pages 1-19, it is possible to calculate p according to the confidentiality parameters relating to the confidentiality of each binary element bᵢ by:

exp(−ε)·Pr[flip(1)]=bᵢ]≦Pr[flip(0)=bᵢ]≦exp(ε)·Pr[flip(1)=bᵢ]

wherein exp represents the exponential function and Pr[A] the probability of an event A. A binary element bᵢ has the value 0 or 1.

The confidentiality ε of each binary element bᵢ according to this confidentiality metric is ensured for a probability value p such that:

$$\frac{1}{1 + exp ( ɛ )} \leq p \leq \frac{1}{2} .$$

In an alternative example, the probability value p is calculated in order to ensure confidentiality at the elements pᵢ present in the user profile from which the data structure is calculated. For this, the number K of hash functions is also taken into account.

The following metric is used. Let there be two profiles PU1 and PU2 which only differ by a single element pᵢ, present in PU1 and absent in PU2. The initial data structures obtained by Bloom filtering associated with these profiles are noted as P_{N1} and P_{N2}, and P*_{N1} and P*_{N2} are the masked data structures obtained by applying a probabilistic inversion operation according to the embodiment described above.

A confidentiality parameters is defined by the following equations:

exp(−ε)Pr[pᵢεP_{N2}*]≦Pr[pᵢεP_{N1}*]≦exp(ε)Pr[pᵢεP_{N2}*]

exp(−ε)Pr[pᵢεP_{N1}*]≦Pr[pᵢεP_{N2}*]≦exp(ε)Pr[pᵢεP_{N1}*]

The confidentiality of each present element pᵢ according to this confidentiality metric is ensured for a probability value p such that:

$$\frac{1}{1 + exp ( ɛ / K )} \leq p \leq \frac{1}{2}$$

wherein K is the number of hash functions used in Bloom filtering.

Step 34 is followed by a step 36 for publishing in the network the calculated masked representation P*_{N}.

The example described above includes the application of Bloom filtering for obtaining an initial representation in the form of an initial data structure, and then the application of a probabilistic inversion operation for obtaining a masked representation with an associated confidentiality level.

According to an alternative example, if the set P of possible elements pᵢ in a user profile is countable and finite, equal to a number G of possible elements, in step 32 the initial representation of the user profile is obtained by generating an initial data structure in the form of a vector with size G, indicating the presence or the absence of an element in the user profile: P_{N}=[b₁, . . . , b_{G}] wherein bᵢ=1 if the element pᵢ is present in the user profile, and bᵢ=0 if the element pᵢ is absent from the user profile.

In this example, the step 34 for applying a probabilistic inversion operation is applied on this vector P_{N}, in the way explained above. The step 34 is followed by an optional step, not shown in FIG. 3, for applying a Bloom filter after the probabilistic inversion operation.

FIG. 4 illustrates the steps of a method for estimating similarity between nodes of a distributed network having associated user profiles according to an example of the invention. In this embodiment, the similarity estimation method is applied on a first node A of the distributed network, which carries out the estimation of similarity between its own associated user profile and the associated user profile with a second node B of the network.

In order to carry out the estimation of similarity, the data structures calculated as detailed above with reference to FIG. 3, i.e. the initial data structure P_{A} of the node A and the masked data structure P*_{B} representative of a profile of node B, are used.

The similarity estimation method is applied by a central processing unit 16 of a programmable device 10 associated with a node A.

In a first step 40, the node A receives, from node B, a masked data structure P*_{B} representative of the elements present in the user profile of the node B. As explained earlier, the masked data structure or public profile P*_{B} of the node B has a confidentiality guarantee with a pre-determined confidentiality level.

Next in step 42, the node A recovers an initial data structure P_{A} representative of the user profile associated with this node A. It is not necessary to use the masked data structure P*_{A}, since the node A does not need to guarantee confidentiality insofar that the computations are carried out on this node.

In practice, the initial data structure P_{A} is computed as explained above with reference to FIG. 3, or recovered in a memory 18 of the programmable device 10 if it was computed previously.

In the example, the representations of data are calculated by applying Bloom filtering, and then by applying a probabilistic inversion operation in order to obtain a masked data structure.

In the next step 44, a computation for estimating the similarity between the user profiles of the nodes A and B is carried out. As the node A does not have any private profile of the node B, P_{B}, only an estimation of similarity from both present data structures, P_{A} and P*_{B} respectively, may be computed.

According to the embodiment, the estimator of the similarity between the node A and the node B is computed from the scalar product between P_{A} and P*_{B}. The scalar product is equivalent to a cosine similarity measurement for binary vectors.

If it is noted that P_{A}={b₀, . . . , b_{M-1}} et P*_{B}={v₀, . . . , v_{M-1}}, the scalar product SP is:

$$S P = {\sum }_{i = 0}^{M - 1} {b}_{i} {v}_{i}$$

In order to obtain an unbiased estimator, SP*, i.e. an estimator for which the expectation value is equal to the expectation value of the scalar product between P_{A} and P_{B}, the following formula is applied:

$$s ( A , B ) = S {P}^{*} = \frac{{\sum }_{i = 0}^{M - 1} {b}_{i} {v}_{i} - p {\sum }_{i = 0}^{M - 1} {b}_{i}}{1 - 2 p}$$

Alternatively, an unbiased estimator is calculated on the basis of a binary sum BS between the data structures representative of the profiles P_{A} and P*_{B}:

$$B {S}^{*} = \frac{B S - p}{1 - 2 p} wherein B S = {\sum }_{i = 0}^{M - 1} {b}_{i}$$

Thus, a similarity estimation between nodes A and B is obtained on node A, from the public profile of node B and from the private profile of node A.

Alternatively, each of the nodes A and B sends its public profile, P*_{A} and P*_{B} respectively, to a central server or to a third party node, different from the nodes A and B, which carry out a similarity estimation calculation between the user profiles of the nodes A and B. In this case, it is also possible to obtain an unbiased estimator SP* for the calculation of similarity, wherein: P*_{A}={u₀, . . . , u_{M-1}} and P*_{B}={v₀, . . . , v_{M-1}}:

$$s ( A , B ) = S {P}^{*} = \frac{( 2 p - 1 ) p ( {\sum }_{i = 0}^{M - 1} {u}_{i} + {\sum }_{i = 0}^{M - 1} {v}_{i} ) + S \tilde{P} - {np}^{2}}{{( 1 - 2 p )}^{2}}$$

$$with$$

$$S \tilde{P} = {np}^{2} + ( p - 2 {p}^{2} ) ( {\sum }_{i = 0}^{M - 1} {u}_{i} + {\sum }_{i = 0}^{M - 1} {v}_{i} ) + ( 1 - 4 p + 4 {p}^{2} ) {\sum }_{i = 0}^{M - 1} {u}_{i} {v}_{i}$$

Advantageously, the various similarity estimators explained above have good performances for obtaining nodes similar to a given node, i.e. having a user profile close to the user profile of the given node.

Thus, by means of the invention, a user profile is both masked in order to guarantee its confidentiality and to ensure that it may be distributed to a third party without any risk of disclosing its private data, while remaining useable for similarity calculations between user profiles.

1. A method for masking data making up a user profile associated with a node of a network applied by a programmable device, a user profile being made up from a sub-set of elements present among a set of possible elements, comprising:
obtaining an initial data structure including a predetermined number of binary elements, a so-called binary element may assume a value between two possible values, the initial data structure being representative of the elements present in the user profile, and
for at least one portion of said binary elements, applying a probabilistic inversion operation of the value of said binary element, depending on a probability value, depending on a predetermined confidentiality parameter, giving the possibility of obtaining a masked data structure representative of the elements present in the user profile.

2. The method according to claim 1, wherein the obtaining step comprises the application of a filtering operation on said sub-set of present elements giving the possibility of obtaining a probabilistic data structure representative of the presence of elements in the user profile from among the set of possible elements with an associated certainty level.

3. The method according to claim 2, wherein said filtering operation is Bloom filtering, associating a number M of binary values with said sub-set of present elements, the M binary values being obtained by a successively and independently applying K hash functions, each hash function producing a pseudo-random association between an element present in the user profile and a corresponding binary element which is set to a first binary value from among the two possible binary values.

4. The method according to one of the preceding claims, wherein said confidentiality parameter is a differential confidentiality parameter ε relating to the confidentiality of the binary elements of said initial data structure, and in that said probability value is comprised between 1/(1+exp(ε)) and 0.5.

5. The method according to claim 3, wherein said confidentiality parameter further depends on the applied number K of hash functions and in that said probability value is comprised between 1/(1+exp(ε/K)) and 0.5.

6. A method for estimating similarity between a first node and a second node of a network applied by a programmable device, each node having an associated user profile, a user profile consisting of a sub-set of elements present from among a set of possible elements, it includes the steps of:
obtaining an initial data structure or a masked data structure obtained by application of a method according to claim 1, representative of the user profile associated with the first node,
receiving a masked data structure representative of the user profile associated with the second node obtained by applying a method according to claim 1, and
estimating a similarity value between said first node and second node depending on said data structures.

7. The similarity estimation method according to claim 6, applied on said first node and in that in the obtaining step, an initial data structure representative of the user profile associated with the first node is obtained.

8. The similarity estimation method according to claim 7, wherein the estimation step includes the calculation of a scalar product between said initial data structure and said masked data structure.

9. The similarity estimation method according to claim 6, applied on a node of the network different from said first node and second node and in that, in the obtaining step, a masked data structure representative of the user profile associated with the first node is obtained.
